(19) United States
(12) Patent Application Publication
(10) Pub. No.: US 2006/0252432 A1
(43) Pub. Date: Nov. 9, 2006

(54) Method and system for enabling venues to selectively block incoming calls to cellular phones present in venue premises

(75) Inventors: Carol Shifrin Gruchala, Naperville, IL (US); Wayne Robert Heinmiller, Elgin, IL (US); Dianna Inara Tiliks, Palatine, IL (US); John Wesley Moss, Lake Zurich, IL (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/124,837

(22) Filed: May 9, 2005

(51) Int. Cl. H04Q 7/20

(52) U.S. Cl. 455/456.3; 455/414.1

(57) ABSTRACT

A method and system for enabling a venue to selectively block incoming calls to cellular phones located at the venue includes the venue providing a provider with a list of selected cellular phones which are to be able to receive incoming calls while located at the venue. In response to receiving an incoming call to a recipient cellular phone, the provider determines whether the recipient phone is a selected phone and compares the recipient phone and venue locations to determine whether the recipient phone is located at the venue. The provider blocks the call if the recipient phone is located at the venue and if the recipient phone is not a selected phone. The provider establishes the call if the recipient phone is located at the venue and if the recipient phone is a selected phone, and the provider establishes the call if the recipient phone is not located at the venue.

### BACKGROUND OF THE INVENTION

1. Field of the Invention

The present invention generally relates to methods and systems for blocking cellular phone calls.

2. Background Art

Venues such as schools, concert halls, movie theaters, etc., have prohibited the use of cellular phones in their premises. That is, venues have prohibited incoming and outgoing cellular phone calls to and from cellular phones present in the venues. For example, schools prohibit students from using cellular phones in school classrooms while school is in session.

Some venues simply posted public notices in their premises that the use of cellular phones within their premises was prohibited in order to enforce the prohibition. Other venues directly enforced the prohibition by having cellular service providers scramble cellular phone calls to and from cellular phones present in the venues. For example, some hotels have cellular service providers scramble cellular phone calls to and from guests present in their hotel rooms. In any event, venues had set forth or enforced the prohibition in order to block all (incoming and outgoing) cellular phone calls to and from cellular phones present in the venues.

A problem with blocking or prohibiting cellular phone calls to and from persons present in a venue is that emergency (incoming and outgoing) cellular phone calls are also blocked. In view of emergency issues, many venues have relaxed the prohibition by allowing persons present in their premises to make outgoing cellular phone calls. However, venues still desire to prohibit incoming cellular phone calls because such calls are a disturbance to other persons. For instance, schools desire to prohibit incoming cellular phone calls to students because such calls disturb students while school is in session. Likewise, concert halls and movie theaters desire to prohibit incoming cellular phone calls to their patrons because such calls disturb the concert or movie event for the other patrons.

Some venues which prohibit incoming cellular phone calls now allow persons in their premises to receive incoming cellular phone calls during certain time periods. For instance, some schools allow students to have cellular phones but require that such phones not be used during the school day. Likewise, concert halls and movie theaters do not wish to prohibit incoming cellular phone calls after the concert or movie event has ended.

### BRIEF DESCRIPTION OF THE DRAWINGS

FIG. 1 illustrates a block diagram of a communications network for enabling venues to selectively block incoming calls to cellular phones present in their premises in accordance with an embodiment of the method and system of the present invention;

FIG. 2 illustrates a flowchart describing operation carried out by a venue to instruct a cellular service provider which cellular phones located within the venue are to be able to receive incoming cellular phone calls while located within the venue in accordance with an embodiment of the method and system of the present invention; and

FIG. 3 illustrates a flowchart describing operation carried out by the cellular service provider in response to receiving an incoming cellular phone call in accordance with an embodiment of the present invention.

### DETAILED DESCRIPTION OF THE PREFERRED EMBODIMENT(S)

The method and system for enabling venues to selectively block incoming calls to cellular phones present in their premises in accordance with the present invention has many advantages. For example, the method and system enable a venue to prohibit incoming cellular phone calls to all but a select group of cellular phones present in the venue while enabling all cellular phones present in the venue to make outgoing cellular phone calls.

The method and system generally provide a “geographic call manager” service to venues such as schools which enables the venues to selectively block incoming cellular phone calls to cellular phones present within their premises while allowing all outgoing cellular phone calls from cellular phones present within their premises. The venues select the groups of cellular phones which are to be allowed to receive incoming cellular phone calls while present in the venues.

The geographic call manager service addresses emergency issues by enabling venues to selectively block incoming cellular phone calls to their premises while allowing all outgoing cellular phone calls from their premises. For example, the geographic call manager service enables venues to selectively allow certain individuals to be able to receive incoming cellular phone calls while present in the venues. For instance, schools can select principals and teachers to be able to receive incoming cellular phone calls while present in the school, concert halls and movie theaters can select doctors to be able to receive incoming cellular calls while present in the concert hall or movie theater, etc. As such, individuals selected by the venues are able to receive incoming emergency cellular phone calls while present in the venues. Likewise, all outgoing cellular phone calls are allowed for all individuals present in the venues. As such, any individual present in a venue can make an outgoing emergency cellular phone call in case of an emergency within the venue.

In accordance with an embodiment of the present invention, the geographic call manager service enables a venue to store with cellular service providers a list of exempt cellular phone numbers. An exempt cellular phone number corresponds to the cellular phone of an individual that is allowed by the venue to have at least some access of receiving incoming cellular phone calls while present in the venue. The cellular service providers transfer incoming cellular phone calls to the exempt cellular phones present in the venue while blocking all other incoming calls to the other cellular phones present in the venue.

Again, the venue selects the exempt cellular phones for individuals that are to have the ability to receive incoming cellular phone calls while present in the venue. Such an exempt list of individuals could include principals and teachers (while present in schools), doctors (while present in concert halls or movie theaters), etc. As such, the lines of incoming cellular communications terminating to cellular phones within the venue are not totally blocked. Further, the cellular service providers allow all cellular phones present within the venue to originate outgoing cellular phone calls. As such, none of the lines of outgoing cellular phone communications originating from cellular phones within the venue are blocked.

In accordance with an embodiment of the present invention, the geographic call manager service enables a venue to store with cellular service providers a list of permitted and non-permitted usage periods in which cellular phones present in the venue are able and not able to receive incoming cellular phone communications while present in the venue. Thus, the geographic call manager service enables venues to set forth time-of-day/day-of-week/day-of-year (TOD/DOW/DOY) functionality to allow incoming cellular phone calls to cellular phones within the venue during certain time periods. For example, the venue may be a school and the permitted time periods include weekends and after school hours. In this case, all cellular phones present within the school grounds are able to receive incoming cellular phone calls during weekends or after school. As another example, the venue may be a movie theater and the permitted time periods include times when the movie has ended. In this case, all patrons present in the movie theater are allowed to receive incoming cellular phone calls while present in the movie theater after the movie has ended.

In accordance with an embodiment of the present invention, the geographic call manager service enables a venue to associate a permanent or temporary basis with the exempt cellular phone numbers. For example, the venue can associate a permanent basis with an exempt cellular phone such that the cellular phone is allowed to receive incoming cellular phone calls while present in the venue until the venue decides otherwise. In this case, the venue simply removes the cellular phone from the stored exempt list once the venue decides that the cellular phone is no longer allowed to receive incoming cellular phone calls while present in the venue. As another example, the venue can associate a temporary basis with a listed exempt cellular phone such that the cellular phone is allowed to receive incoming cellular phone calls while present in the venue only at certain time periods (i.e., allowing the exempt cellular phone to receive incoming cellular phone calls only during certain time periods of the day while present in the venue).

Accordingly, in accordance with the present invention, the geographic call manager service allows a venue to provide exceptions to the general rule of blocking incoming cellular phone calls to cellular phones located in the venue.

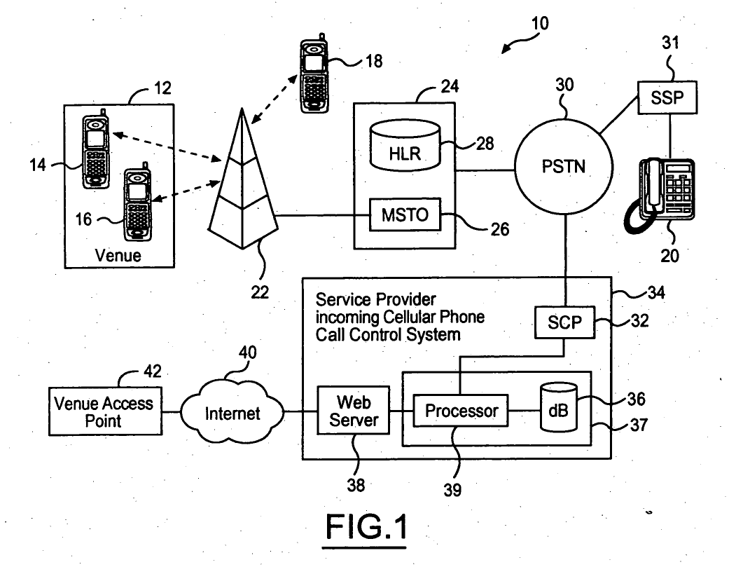

Referring now to FIG. 1, a block diagram of a communications network 10 for enabling venues to selectively block incoming calls to cellular phones present in the venues in accordance with an embodiment of the method and system of the present invention is shown. More particularly, communications network 10 enables venues to selectively block incoming cellular phone calls from individuals outside of the venues to individuals present within the geographic vicinity of the venues.

In operation, at least one or more individuals are physically located within the premises of a venue 12. Some of these individuals have cellular phones. For example, as shown in FIG. 1, two individuals having respective cellular phones 14 and 16 are physically located in venue 12. As such, cellular phones 14 and 16 are physically located in venue 12. Other individuals are physically located outside of the geographic vicinity of venue 12. For example, as shown in FIG. 1, an individual having a cellular phone 18 is physically located outside of venue 12. Likewise, as shown in FIG. 1, an individual having a land-line telephone 20 is physically located outside of venue 12. As such, cellular phone 18 and telephone 20 are physically located outside of the geographic vicinity of venue 12.

Communications network 10 includes cellular infrastructure 22 such as a cellular tower for establishing cellular phone calls between cellular phones 14, 16, and 18, and telephone 20 as is known in the art. For example, when a cellular phone call is established between cellular phones 14 and 18, cellular tower wirelessly transmits communications between cellular phones 14 and 18.

Communications network 10 further includes a service switching point (SSP) 24 having a mobile telephone switching office (MTSO) 26 and a home location register (HLR) database 28. For simplicity, SSP 24 with MTSO 26 and HLR database 28 form part of the wireless communications network of one cellular service provider that provides cellular phone services to cellular phones 14, 16, and 18. MTSO 26 communicates cellular tower 22 to generally control the wireless communications aspects of communications network 10. General functions handled by MTSO 26 include monitoring calls, keeping track of the location of the mobile users, keeping track of billing, switching calls to a wire-based (land-line) central office, etc. In accordance with the present invention, other functions of MTSO 26 include blocking incoming cellular phone calls to all but a group of cellular phones selected by venue 12 while present within the vicinity of the venue during times designated by the venue. Correspondingly, MTSO 26 functions to complete incoming cellular phone calls to the selected cellular phones present within the vicinity of venue 12 during the designated times.

MTSO 24 communicates with the public switched telephone network (PTSN) 30 in order to establish cellular phone calls between cellular phones 14, 16, and 18, and telephone 20 as is known in the art. To this end, telephone 20 communicates with PTSN 30 via a SSP 31 in order to make and receive phone calls to and from cellular phones 14, 16, and 18 as is known in the art.

MTSO 26 communicates with a signal control point (SCP) 32 of an incoming cellular phone call control system 34. Control system 34 is preferably associated with a cellular service provider but may, for example, be associated with an LEC or third party which acts as the screening agent for venue 12. Control system 34 further includes an incoming cellular cell phone sub-control system 37 having a database 36 and a processor 39. In accordance with the present invention, database 36 stores information provided by venue 12 regarding incoming cellular phone call prohibitions. It is pointed out that such information may also be stored by HLR 28 of SSP 24. Further, part of such information may be stored in HLR 28 and the other part of such information may be stored in database 36.

Again, it is noted that venue 12 provides the information regarding incoming cellular phone all prohibitions. To this end, control system 34 includes a web server 38 which communicates with Internet 40. Venue 12 accesses web server 38 using a venue access point 42 (such as a computer) connected to Internet 40. Venue 12 accesses web server 38 to provide information to the cellular service provider regarding incoming cellular phone call prohibitions.

More particularly, venue 12 communicates with control system 36 to instruct the cellular service provider to generally block incoming cellular phone calls to cellular phones present within the geographic location of the venue. Venue 12 further communicates with control system 36 to instruct the cellular service provider to provide exceptions to this general rule. For instance, venue 12 communicates with control system 36 to instruct the cellular service provider to generally block incoming cellular phone calls to cellular phones present within the geographic location of the venue during designated times. As such, during other times, the cellular service provider does not block incoming cellular phone calls to cellular phones present within the geographic location of venue 12 during other times. Venue 12 also communicates with control system 36 to instruct the cellular service provider to not block incoming cellular phone calls to certain cellular phones present within the geographic location of the venue during any time (or during designated times).

Control system 36 is operable to enable venue 12 to register a venue profile with the cellular service provider. The venue profile includes the geographic location of venue 12. For example, the geographic location of venue 12 may be derived from street address coordinates of the venue. As another example, the geographic location of venue 12 may be automatically derived by the cellular service provider based on the physical location of venue access point 42. In any event, the geographic location of venue 12 is established with the cellular service provider and the cellular service provider may verify such information using automatic or manual means.

As a result of the incoming cellular phone call prohibition instructions made by venue 12 to control system 36 of the cellular service provider, the venue profile stored by database 36 (and/or HLR 28) generally includes three pieces of information. The first piece of information is the geographic location of venue 12. The second piece of information is a list of exempt cellular phone numbers corresponding to cellular phones which are to be allowed to receive incoming cellular phone calls while located within the vicinity of the geographic location of venue 12. As such, the cellular service provider does not block incoming cellular phone calls to the cellular phones corresponding to the exempt list of cellular phone numbers while located within the vicinity of venue 12. Correspondingly, the cellular service provider blocks incoming cellular phone calls to the cellular phones which are not listed as exempt while located within the vicinity of venue 12.

The third piece of information relates to the permitted and non-permitted usage time periods. The permitted usage time periods are the time periods in which the cellular service provider is not to block incoming cellular phone calls. The non-permitted usage time periods are the time periods in which the cellular service provider is to block incoming cellular phone calls. The permitted and non-permitted usage time periods may be associated with the list of exempt cellular phone numbers. For example, a cellular phone number may be listed as exempt from the general prohibition of incoming cellular phone calls during permitted time periods while being subject to the general prohibition during the remaining time periods (i.e., the non-permitted usage time periods).

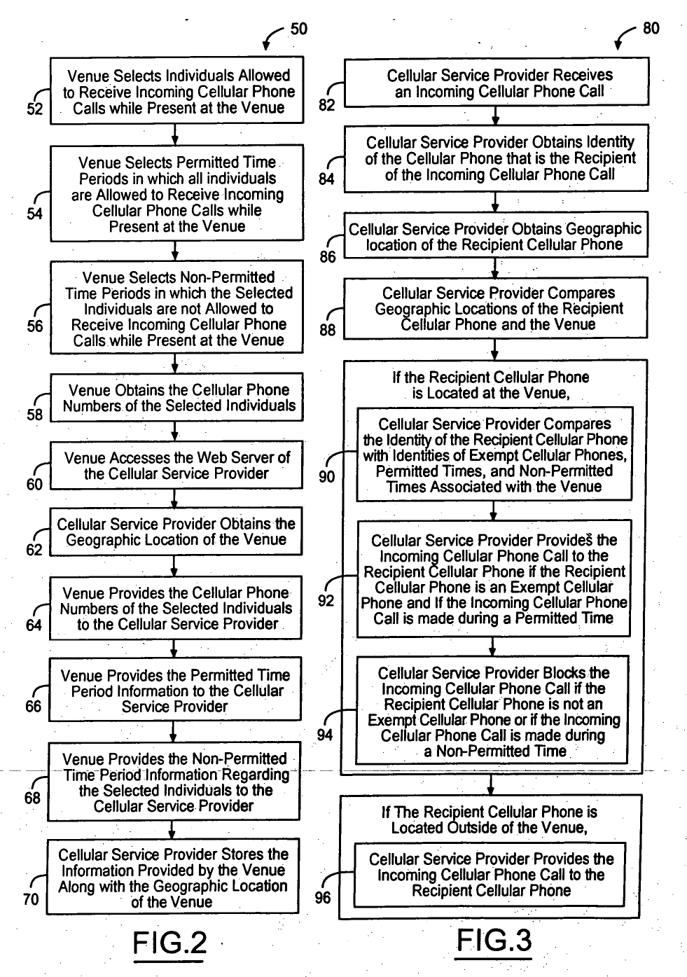

Referring now to FIG. 2, with continual reference to FIG. 1, a flowchart 50 describing operation carried out by venue 12 to instruct the cellular service provider which cellular phones located within the venue are to be able to receive incoming cellular phone calls while located within the venue in accordance with an embodiment of the method and system of the present invention is shown. The operation initially begins with venue 12 selecting the individuals which are to be allowed to receive incoming cellular phone calls while located at the venue as shown by block 52. The selected individuals are to be exempt from the general prohibition carried out by the cellular service provider of blocking incoming cellular phone calls to venue 12. For example, venue 12 is a school and the selected individuals include the school principals and teachers. Venue 12 selects permitted time periods in which all individuals are allowed to receive incoming cellular phone calls while located at the venue as shown in block 54. For example, venue 12 is a school and the permitted time periods include after school hours. Venue 12 selects non-permitted time periods in which the selected individuals are not allowed to receive incoming cellular phone calls while located at the venue as shown in block 56. Venue 12 obtains the cellular phone numbers of the cellular phones belonging to the selected individuals as shown in block 58.

Venue 12 then uses venue access point 42 to access web server 38 of the cellular service provider as shown in block 60 in order to communicate to the cellular service provider the information selected by the venue. In turn, the cellular service provider obtains the geographic location of venue 12 as shown in block 62. This may be done by communications to venue 12 via web server 38. Alternatively, the geographic location of venue 12 is previously registered with the cellular service provider or determined by the cellular service provider by some other means.

While accessing web server 38, venue 12 provides to the cellular service provider the cellular phone numbers of the selected individuals as shown in block 64. Venue 12 further provides the permitted time period information to the cellular service provider as shown in block 66. Venue 12 also provides the non-permitted time period information regarding the selected individuals to the cellular service provider as shown in block 68. In turn, the cellular service provider stores the information provided by venue 12 along with the geographic location of the venue in database 36 (and/or HLR 28) as shown in block 70. The cellular service provider then blocks and allows incoming cellular phone calls to cellular phones located at venue 12 in accordance with the information provided by the venue.

Referring now to FIG. 3, with continual reference to FIGS. 1 and 2, a flowchart 80 describing operation carried out by the cellular service provider in response to receiving an incoming cellular phone call in accordance with an embodiment of the present invention is shown. The operation initially begins with the cellular service provider receiving an incoming cellular phone call as shown in block 82. For instance, MTSO 26 receives the incoming cellular phone call. The cellular service provider then obtains the identity of the cellular phone that is the recipient of the incoming cellular phone call as shown in block 84. For instance, the identity is the cellular phone number of the recipient cellular phone and MTSO 26 obtains this cellular phone number from the incoming cellular phone call. Using the identity of the recipient cellular phone, the cellular service provider obtains the geographic location of the recipient cellular phone as shown in block 86. The cellular service provider obtains the geographic location of the recipient cellular phone using a global positioning system or other such suitable techniques.

The cellular service provider then obtains the stored venue profile of a venue 12 and compares the geographic location of the recipient cellular phone with the geographic location of the venue as shown in block 88. The geographic location of the venue is part of the information stored by the cellular service provider as described above. The cellular service provider compares the two geographic locations to determine whether or not the recipient cellular phone is located at or within the vicinity of the venue. For example, if the recipient cellular phone is cellular phone 14, then the cellular service provider determines that cellular phone 14 is at the location of venue 12. Likewise, if the recipient cellular phone is cellular phone 18, then the cellular service provider determines that cellular phone 18 is not at the location of venue 12.

If the recipient cellular phone (such as cellular phone 14) is located at venue 12, then the cellular service provider compares the identity of the recipient cellular phone with a list of exempt cellular phone numbers associated with venue 12, a list of permitted incoming call times associated with the venue, and a list of non-permitted incoming call times associated with the venue as shown in block 90. The cellular service provider stores these lists as part of the venue profile for venue 12. The cellular service provider compares the identity of the recipient cellular phone with the list of exempt cellular phone numbers to determine whether or not the recipient cellular phone is authorized by venue 12 as an exception to the general rule of being prevented from receiving incoming cellular phone calls while located at the venue. Likewise, the cellular service provider compares the identity of the recipient cellular phone with the lists of permitted and non-permitted times to determine whether or not the recipient cellular phone is authorized by venue 12 as an exception to the general rule of not being prevented from receiving incoming cellular phone calls while located at the venue during specified time periods.

Assuming that the recipient cellular phone is located at venue 12, the cellular service provider provides the incoming cellular phone call to the recipient cellular phone if the recipient cellular phone is an exempt cellular phone and if the incoming cellular phone call is made during a permitted time as shown in block 92. Alternatively, the cellular service provider blocks the incoming cellular phone call to the recipient cellular phone if the recipient cellular phone is not an exempt cellular phone or if the incoming cellular phone call is made during a non-permitted time as shown in block 94. For example, assuming that the recipient, cellular phone is cellular phone 16 located within venue 12, the cellular service provider blocks the incoming cellular phone call to cellular phone 16 if cellular phone 16 is not listed by the venue as being an exception to the general rule. Likewise, assuming that the recipient cellular phone is cellular phone 14 located within venue 12 and listed by the venue as being exempt from the general rule, the cellular service provider still blocks the incoming cellular phone call to cellular phone 14 if the incoming cellular phone call is made during a non-permitted time associated with cellular phone 14.

If the recipient cellular phone (such as cellular phone 18) is located outside of venue 12, then the cellular service provider provides the incoming cellular phone call to the recipient cellular phone as shown in block 96.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A method for enabling a venue to selectively block incoming calls to cellular phones located at the venue, the method comprising:
obtaining a location of a venue;
selecting, by the venue, cellular phones which are to be able to receive incoming calls while located at the venue;
storing, by a provider, the venue location and a list of identities corresponding to the cellular phones selected by the venue which are to be able to receive incoming calls while located at the venue;
receiving an incoming call to a recipient cellular phone;
obtaining an identity of the recipient cellular phone and obtaining a location of the recipient cellular phone at the time the incoming call is received;
comparing the identity of the recipient cellular phone with the list of selected cellular phone identities to determine whether or not the recipient cellular phone is a cellular phone selected by the venue to be able to receive incoming calls while located at the venue;
comparing the recipient cellular phone location with the venue location to determine whether or not the recipient cellular phone is located at the venue at the time the incoming call is received;
blocking, by the provider, the incoming call to the recipient cellular phone if the recipient cellular phone is located at the venue at the time the incoming call is received and if the recipient cellular phone is not a cellular phone selected by the venue to be able to receiving incoming calls while located at the venue;
establishing, by the provider, the incoming call to the recipient cellular phone if the recipient cellular phone is located at the venue at the time the incoming call is received and if the recipient cellular phone is a cellular phone selected by the venue to be able to receive incoming calls while located at the venue; and
establishing, by the provider, the incoming call to the recipient cellular phone if the recipient cellular phone is not located at the venue at the time the incoming call is received.

2. The method of claim 1 further comprising:
receiving an outgoing call from a cellular phone located in the venue for a recipient phone located outside of the venue; and
establishing, by the provider, the outgoing call from the cellular phone located in the venue to the recipient phone located outside of the venue irrespective of the cellular phone being located in the venue.

3. The method of claim 1 further comprising:
selecting, by the venue, permitted time periods in which cellular phones are to be able to receive incoming calls while located at the venue;
storing, by the provider, the permitted time periods;
comparing the time the incoming call is received with the permitted time periods in order to determine whether or not the incoming call is received during a permitted time period; and
establishing, by the provider, the incoming call to the recipient cellular phone if the recipient cellular phone is located at the venue at the time the incoming call is received and if the incoming call is received during a permitted time period regardless of whether or not the recipient cellular phone is selected by the venue to be able to receive incoming calls while located at the venue.

4. The method of claim 1 further comprising:
selecting, by the venue, permitted time periods in which cellular phones selected by the venue to be able to receive incoming calls while located at the venue are permitted by the venue to receive incoming calls if the incoming calls are received during a permitted time period;
storing, by the provider, the permitted time periods;
comparing the time the incoming call is received with the permitted time periods in order to determine whether or not the incoming call is received during a permitted time period; and
establishing, by the provider, the incoming call to the recipient cellular phone if the recipient cellular phone is located at the venue at the time the incoming call is received, if the recipient cellular phone is a cellular phone selected by the venue to be able to receive incoming calls while located at the venue, and if the incoming call is received during a permitted time period.

5. The method of claim 1 further comprising:
selecting, by the venue, non-permitted time periods in which cellular phones are not to receive incoming calls while located at the venue;
storing, by the provider, the non-permitted time periods;
comparing the time the incoming call is received with the non-permitted time periods in order to determine whether or not the incoming call is received during a non-permitted time period; and
blocking, by the provider, the incoming call to the recipient cellular phone if the recipient cellular phone is located at the venue at the time the incoming call is received and if the incoming call is received during a non-permitted time period regardless of whether or not the recipient cellular phone is selected by the venue to be able to receive incoming calls while located at the venue.

6. The method of claim 1 further comprising:
selecting, by the venue, non-permitted time periods in which cellular phones selected by the venue to be able to receive incoming calls while located at the venue are not permitted by the venue to receive incoming calls if the incoming calls are received during a non-permitted time period;
storing, by the provider, the non-permitted time periods;
comparing the time the incoming call is received with the non-permitted time periods in order to determine whether or not the incoming call is received during a permitted time period; and
blocking, by the provider, the incoming call to the recipient cellular phone if the recipient cellular phone is located at the venue at the time the incoming call is received and if the incoming call is received during a non-permitted time period regardless of whether or not the recipient cellular phone is selected by the venue to be able to receive incoming calls while located at the venue.

7. The method of claim 1 wherein:
the identities of the cellular phones selected by the venue to be able to receive incoming calls while located at the venue include the cellular phone numbers corresponding to the selected cellular phones;
wherein the identity of the recipient cellular phone includes the cellular phone number of the recipient cellular phone.

8. The method of claim 7 wherein:
selecting, by the venue, the cellular phones which are to be able to receive incoming calls while located at the venue includes the venue providing the provider with a list of cellular phone numbers corresponding to the selected cellular phones.

9. The method of claim 8 wherein:
providing, by the venue, the list of cellular phone numbers corresponding to the selected cellular phones includes the venue communicating the list of cellular phone numbers to the provider via a web server.

10. The method of claim 3 wherein:
selecting, by the venue, permitted time periods in which cellular phones are to be able to receive incoming calls while located at the venue includes the venue communicating the permitted time periods to the provider via a web server.

11. The method of claim 4 wherein:
selecting, by the venue, permitted time periods in which cellular phones selected by the venue to be able to receive incoming calls while located at the venue are permitted by the venue to receive incoming calls if the incoming calls are received during a permitted time period includes the venue communicating the permitted time periods to the provider via a web server.

12. The method of claim 5 wherein:
selecting, by the venue, non-permitted time periods in which cellular phones are not to receive incoming calls while located at the venue includes the venue communicating the non-permitted time periods to the provider via a web server.

13. The method of claim 6 wherein:
selecting, by the venue, non-permitted time periods in which cellular phones selected by the venue to be able to receive incoming calls while located at the venue are not permitted by the venue to receive incoming calls if the incoming calls are received during a non-permitted time period includes the venue communicating the non-permitted time periods to the provider via a web server.

14. A system for enabling a venue to selectively block incoming calls to cellular phones located at the venue, the system comprising:
a provider operable for obtaining a location of a venue; and
a communications interface operable for enabling a venue to communicate with the provider, wherein the venue communicates to the provider a list of cellular phones which are to be able to receive incoming calls while located at the venue;
wherein in response to receiving an incoming call to a recipient cellular phone, the provider obtains an identity of the recipient cellular phone and obtains a location of the recipient cellular phone at the time the incoming call is received;
the provider then compares the identity of the recipient cellular phone with identities of the selected cellular phone to determine whether or not the recipient cellular phone is a cellular phone selected by the venue to be able to receive incoming calls while located at the venue;
the provider then compares the recipient cellular phone location with the venue location to determine whether or not the recipient cellular phone is located at the venue at the time the incoming call is received;
wherein the provider blocks the incoming call to the recipient cellular phone if the recipient cellular phone is located at the venue at the time the incoming call is received and if the recipient cellular phone is not a cellular phone selected by the venue to be able to receiving incoming calls while located at the venue;
wherein the provider establishes the incoming call to the recipient cellular phone if the recipient cellular phone is located at the venue at the time the incoming call is received and if the recipient cellular phone is a cellular phone selected by the venue to be able to receive incoming calls while located at the venue;
wherein the provider establishes the incoming call to the recipient cellular phone if the recipient cellular phone is not located at the venue at the time the incoming call is received.

15. The system of claim 14 wherein:
in response to receiving an outgoing call from a cellular phone located in the venue for a recipient phone located outside of the venue, the provider establishes the outgoing call from the cellular phone located in the venue to the recipient phone located outside of the venue irrespective of the cellular phone being located in the venue.

16. The system of claim 14 wherein:
the communications interface includes a web server.

17. The system of claim 14 wherein:
the identities of the selected cellular phones and the identity of the recipient cellular phone includes the cellular phone numbers corresponding to the cellular phones.

18. The system of claim 14 wherein:
the venue communicates to the provider permitted time periods in which cellular phones are to be able to receive incoming calls while located at the venue;
wherein the provider compares the time the incoming call is received with the permitted time periods in order to determine whether or not the incoming call is received during a permitted time period; and
wherein the provider establishes the incoming call to the recipient cellular phone if the recipient cellular phone is located at the venue at the time the incoming call is received and if the incoming call is received during a permitted time period regardless of whether or not the recipient cellular phone is selected by the venue to be able to receive incoming calls while located at the venue.

19. The system of claim 14 wherein:
the venue communicates to the provider non-permitted time periods in which cellular phones are not to receive incoming calls while located at the venue;
wherein the provider compares the time the incoming call is received with the non-permitted time periods in order to determine whether or not the incoming call is received during a non-permitted time period; and
wherein the provider blocks the incoming call to the recipient cellular phone if the recipient cellular phone is located at the venue at the time the incoming call is received and if the incoming call is received during a non-permitted time period regardless of whether or not the recipient cellular phone is selected by the venue to be able to receive incoming calls while located at the venue.

20. The system of claim 14 wherein:
the venue communicates to the provider non-permitted time periods in which cellular phones selected by the venue to be able to receive incoming calls while located at the venue are not permitted by the venue to receive incoming calls if the incoming calls are received during a non-permitted time period;
wherein the provider compares the time the incoming call is received with the non-permitted time periods in order to determine whether or not the incoming call is received during a permitted time period; and
wherein the provider blocks the incoming call to the recipient cellular phone if the recipient cellular phone is located at the venue at the time the incoming call is received and if the incoming call is received during a non-permitted time period regardless of whether or not the recipient cellular phone is selected by the venue to be able to receive incoming calls while located at the venue.
